(19) United States
(12) Patent Application Publication
(10) Pub. No.: US 2005/0228933 A1
(43) Pub. Date: Oct. 13, 2005

(54) Remote control method and apparatus for USB host

(75) Inventor: Wang-Kai Tsai, Taipei (TW)

Correspondence Address: BRUCE H. TROXELL, SUITE 1404, 5205 LESSBURG PIKE, FALLS CHURCH, VA, 22041, US

(73) Assignee: Uli Electronic Inc.

(21) Appl. No.: 10/945,894

(22) Filed: Sep. 22, 2004

(30) Foreign Application Priority Data
Apr. 2, 2004 (TW) 93109155

(51) Int. Cl. G06F 3/00; G06F 13/20

(52) U.S. Cl. 710/313

(57) ABSTRACT

The invention is to provide a remote control method and apparatus for USB host, the method comprising: converting a first data of USB specification to a data format suitable to be transmitted through a wired/wireless (W/WL) local area network (LAN) at an USB host so as to transmit the converted first data from the host to a remote client; converting the converted first data to a data format of USB specification at the remote client for enabling the converted first data of USB specification to be transmitted to an USB-enable device by way of a USB device. The remote control apparatus for USB host employs the remote client as an W/WL LAN intermediate between the host and an USB device such that it can achieve longer cable runs.

### 1. FIELD OF THE INVENTION

The present invention relates to a method and apparatus for controlling an universal serial bus (USB) host, and more particularly, to a remote control method and apparatus for USB host.

### 2. BACKGROUND OF THE INVENTION

USB, or Universal Serial Bus, is a peripheral bus connectivity standard which was conceived, developed and is supported by a group of leading companies in the computer and telecommunication industries —Compaq, DEC, IBM, Intel, Microsoft, NEC, and Northern Telecom. USB was developed with one goal in mind: to make it easier for users to plug-and-play computer peripherals without having to open the box, install cards into dedicated computer slots and reconfiguring the system.

USB makes it convenient to use and connect peripherals to a computer without using several connectors, different interrupts and 10 addresses. The computer automatically recognizes the device connected and installs the appropriate drivers. It enables computer users to “hot-plug” computer peripherals to their PCs and start using them without having to reboot. USB 2.0 produces data transfer rates, up to 480 Mbps, which enables new classes of high-performance peripherals.

The growth of USB products and related services are outstanding. However, every product has a weakness, and even an interface as praised as USB has its downsides. The most aggravating limitation of USB is the length restriction. Because of the nature in which data is carried through the cable, five meters is the maximum cable length allowed by the USB specification. In this regard, you can either arrange all your USB-enabled peripherals in close proximity of the connected computer, or you can achieve longer cable runs by inserting a hub every five meters or you can chain Active Extension cables to attain the needed distance. Neither are the preferred solutions for the length restriction that can get expensive and massy.

As seen in FIG. 1, which is a schematic diagram showing an operational model of a conventional USB host controller driver, the USB host 100 includes an USB device driver 120 and an USB host controller driver 130, both resided in the USB host 100 as software, and a USB host controller 110, existed in the USB host as hardware. When the USB host 100 is connected to an USB device 140 through an USB cable, the USB host 100 is able to apply the USB device driver 120, the USB host controller driver 130 and the USB host controller 110 to control and access data from the USB device 140.

For instance, while transmitting an USB request block (URB) from the USB host 100 to the USB device 140, the URB is packaged inside an I/O request packet (IRP) by the USB device driver 120 to be transmitted to USB host controller driver 130 for converting the URB into QH/qTD/iTD/siTD format to be received by the USB host controller 110, and then the USB host controller 110 further transfers the URB of QH/qTD/iTD/siTD format into an USB transaction and transmits the same to the USB device 140. In this regard, the USB host 100 can control the USB device 140 by sending URB to the USB device 140.

In a conventional USB host architecture, the USB transaction between the USB host 100 and the USB device 140 can only be proceeded by way of an USB cable, which is limited by the five-meter restriction.

In view of the above description, the present invention provides a remote control method and apparatus for USB host, which can achieve longer cable runs for enabling an optimum operational mode between USB host and USB device.

### SUMMARY OF THE INVENTION

The primary object of the invention is to provide a remote control method for USB host, the method comprising: converting a first data of USB specification to a data format suitable to be transmitted through a wired/wireless (W/WL) local area network (LAN) at an USB host so as to transmit the converted first data from the host to a remote client; converting the converted first data to a data format of USB specification at the remote client for enabling the converted first data of USB specification to be transmitted to an USB-enable device by way of an USB transmission device.

In a preferred embodiment of the invention, the method, at the USB host, further comprises: attaching the packet of USB I/O information to the first data; attaching the packet required for remotely controlling the USB I/O to the first data; attaching the socket required for transmitting/controlling network communication protocol I/O to the first data; and attaching the packet of a W/WL LAN I/O to the first data for enabling the first data to be transmitted to the remote client through the W/WL LAN.

Moreover, at the remote client, the method further comprises: converting the first data of the data format suitable to be transmitted through the W/WL LAN into the first data of USB specification.

Operationally, an USB device driver is used for attaching the packet of USB I/O information to the first data, a remote USB host controller driver is used for attaching the packet required for remotely controlling the USB I/O to the first data, a servo application is used for attaching the socket required for transmitting/controlling network communication protocol I/O to the first data, and a W/WL LAN driver is used for attaching the packet of a W/WL LAN I/O to the first data.

In addition, a virtue bus driver is used for loading/unloading remote USB host controller driver when servo application informs it. As servo application detects appearance or disappearance of the W/WL remote client, it informs virtue bus driver, and then the virtue bus driver take charge of the enumeration of the USB host controller to load or unload remote USB host controller driver. This virtue bus driver is loaded as servo application is loaded.

It is another object of the invention to provide a remote control apparatus for USB host, comprising a host and a remote client. Wherein, the host further comprises a plurality of programs for converting data of USB specification to data of format suitable to be transmitted through a W/WL LAN, and a W/WL LAN transceiver for transmitting/receiving the converted data; and the remote client further comprises a W/WL LAN transceiver for transmitting/receiving data, and a firmware for converting the received data of format suitable to be transmitted through the W/WL LAN into data of USB specification, and an USB host controller for outputting the data transmitted from the firmware.

In a preferred embodiment, the plural programs resided in the host include a virtue bus driver, an USB device driver, a remote USB host controller driver, a servo application, and a W/WL LAN driver.

To sum up, the present invention provides a remote control method and apparatus for USB host, which can achieve longer cable runs for enabling an optimum operational mode between USB host and USB device.

### BRIEF DESCRIPTION OF THE DRAWINGS

FIG. 1 is a schematic diagram showing an operational model of a conventional USB host controller driver

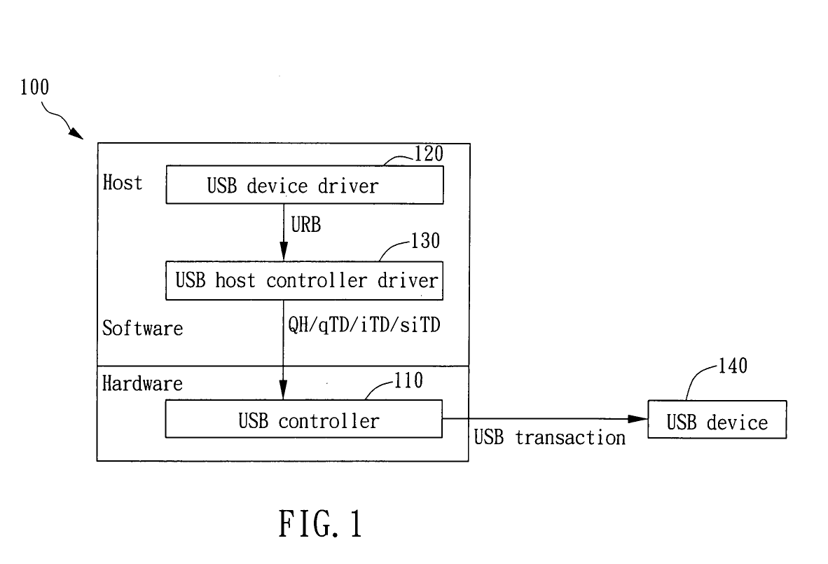

FIG. 2 is a schematic diagram showing an operational model of a remote USB host controller according to the present invention.

FIG. 3 is a schematic diagram showing an operational model of the present invention.

### DESCRIPTION OF THE PREFERRED EMBODIMENT

In a conventional USB host architecture, the USB transaction between an USB host and an USB device can only be proceeded by way of an USB cable, which is limited by the five-meter restriction. Hence, the present invention intends to employ a W/WL LAN as media for achieving longer cable runs so as to enable an optimum operational mode between the USB host and the USB device

For your esteemed members of reviewing committee to further understand and recognize the fulfilled functions and structural characteristics of the invention, several preferable embodiments cooperating with detailed description are presented as the follows.

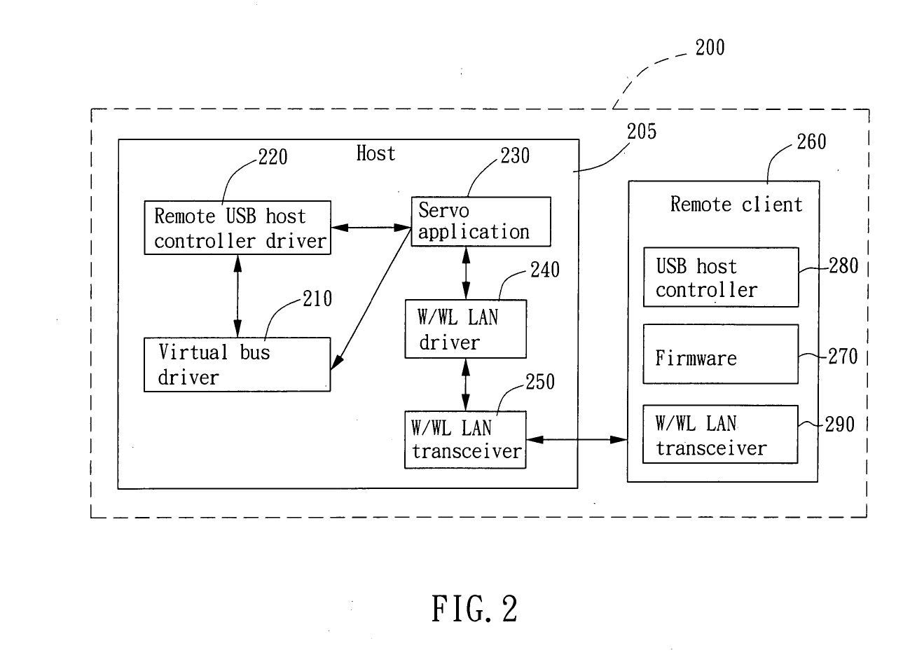

Please refer to FIG. 2, which show a remote control apparatus for USB host of the invention. The remote control apparatus for USB host 200 includes a host 205 and a remote client 260. Wherein, the host 205 further includes a virtue bus driver 210, a remote USB host controller driver 220, a servo application, and a W/WL LAN driver 240, all resided in the host 205 as software, and a W/WL LAN transceiver 250, existed in the host 205 as hardware; and the remote client 260 includes a firmware 260 resided in an EEPROM for controlling the hardware of the remote client 260, and an USB host controller 280, a W/WL LAN transceiver 290, existed in the remote client 260 as hardware.

When the remote client 260 is powered on, it can be detected by the host 205 using the W/WL LAN transceiver 250, the W/WL LAN driver 240 and the servo application 230, such that the servo application 230 will simultaneously direct the virtue bus driver 210 to load the remote USB host controller driver 220. In this regard, as soon as the remote client is powered on, the host 205 can detect and control the remote client 260, and also the USB device connected to the remote client 260 is controlled by the host 205 remotely.

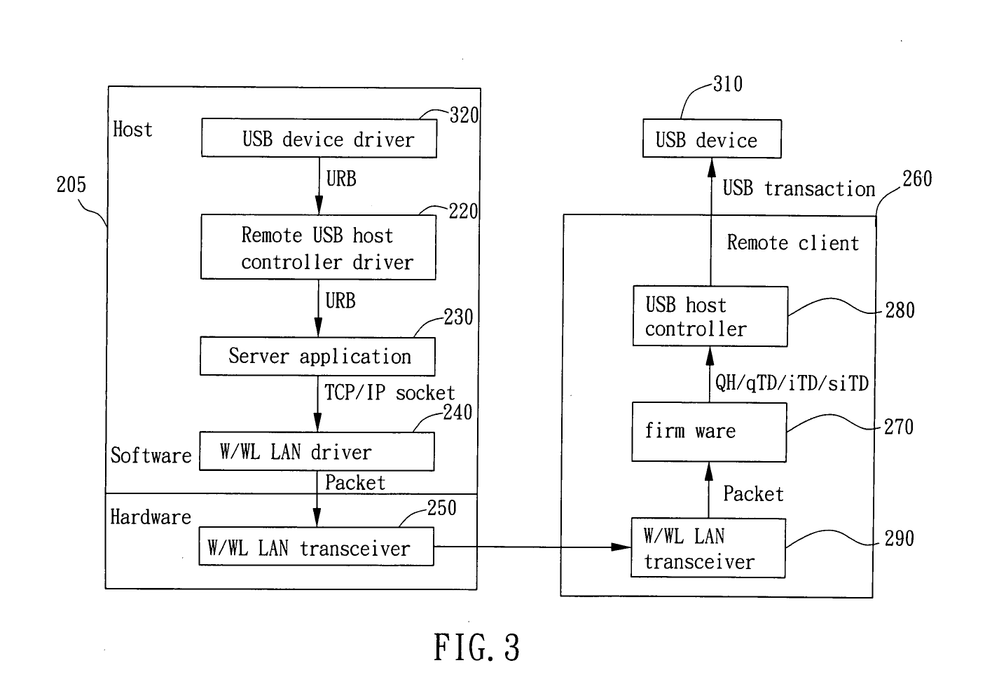

Please refer to FIG. 3, which is a schematic diagram showing an operational model of the present invention. As soon as the remote client 260 is connected to an USB device 310, the host 205 will detect the USB device 310 through the remote client 260 and is able to access the USB device driver of the USB device 310, that the host 205 can control the USB device 310 using the USB device driver.

When the USB device driver 320 of the host 205 issues an URB to control the USB device 310, the URB is packaged inside an I/O request packet (IRP) by the USB device driver 320, and a packet required for remotely controlling the USB I/O is being attached to the IRP by the remote USB host controller driver 220, and a socket required for transmitting/controlling network communication protocol I/O (TCPIP) is being attached to the IRP by the servo application 230, and finally a packet of a W/WL LAN I/O is being attached to the IRP by the W/WL LAN transceiver 250. In this regard, as the W/WL LAN transceiver 250 of the host 205 receives the IRP containing all the required packets and the URB, it is capable of converting the URB into signal of the W/WL LAN suitable to be received by the W/WL LAN transceiver 290 of the remote client 260.

As the signal of the W/WL LAN is received by the W/WL LAN transceiver 290 of the remote client 260, it is decoded by the W/WL LAN transceiver 290 and sent to-the-firmware 270 to be converted back to the original URB of QH/qTD/iTD/siTD format as was issued by the host 205 such that the USB host controller 280 of the remote client can transfer the URB into an USB transaction and output the same to the USB device 310. In this regard, the host 205 is able to send an URB to the USB device 310 connected the remote client 260 through the remote client, and vice versa.

Since the communication between the host and the remote client is achieved by a W/WL LAN, the host is able to control an USB device connected to the remote client remotely without to be limited by the length restriction of USB specification, such that the present invention can achieve longer cable runs for enabling an optimum operational mode between USB host and USB device.

To sum up, the present invention provides a provide a remote control apparatus for USB host, which employs the remote client as an W/WL LAN intermediate between the host and the USB device such that it can achieve longer cable runs for enabling an optimum operational mode between USB host and USB device.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. A remote control method for an USB host, comprising:
converting a first data of USB specification into a data format suitable to be transmitted through a wired/wireless local area network at an host of the USB host so as to transmit the converted first data from the host to a remote client of the USB host;
converting the converted first data to a data format of USB specification at the remote client for enabling the converted first data of USB specification to be transmitted to an USB-enable device by way of an USB transmission device.

2. The method of claim 1, wherein the method further comprises:
attaching the packet of USB I/O information to the first data at the host of the USB host.

3. The method of claim 2, wherein the method further comprises:
attaching the packet required for remotely controlling the USB I/O to the first data at the host of the USB host.

4. The method of claim 3, wherein the method further comprises:
attaching the socket required for transmitting/controlling network communication protocol I/O to the first data at the host of the USB host.

5. The method of claim 4, wherein the method further comprises:
attaching the packet of a W/WL LAN I/O to the first data for enabling the first data to be transmitted to the remote client through the W/WL LAN at the host of the USB host.

6. The method of claim 5, wherein the method further comprises:
converting the first data of the data format suitable to be transmitted through the W/WL LAN into the first data of USB specification at the remote client of the USB host.

7. The method of claim 6, wherein the method further comprises:
using an USB device driver to attach the packet of USB I/O information to the first data.

8. The method of claim 7, wherein the method further comprises:
using a remote USB host controller driver to attach the packet required for remotely controlling the USB I/O to the first data.

9. The method of claim 8, wherein the method further comprises:
using a servo application to attach the socket required for transmitting/controlling network communication protocol I/O to the first data.

10. The method of claim 9, wherein the method further comprises:
using a W/WL LAN driver to attach the packet of a W/WL LAN I/O to the first data.

11. The method of claim 10, wherein the method-further comprises:
using a virtue bus driver to load the remote USB host controller driver.

12. The method of claim 11, wherein the method further comprises:
using the virtue bus driver for loading/unloading the remote USB host controller driver as the servo application detects appearance/disappearance of the remote client and informs the virtue bus driver.

13. The method of claim 12, wherein the method, at the remote client, further comprises:
converting a second data of USB specification into the data of the data format suitable to be transmitted through the W/WL LAN to the host of the USB host.

14. A remote control apparatus for an USB host, comprising:
a host, further comprising:
a plurality of programs, for converting data of USB specification to data of format suitable to be transmitted through a W/WL LAN; and
a first W/WL LAN transceiver, for transmitting/receiving the converted data;
a remote client, further comprising:
a second W/WL LAN transceiver, for transmitting/receiving data from the first W/WL LAN transceiver;
a firmware, for converting the received data of format suitable to be transmitted through the W/WL LAN into data of USB specification; and
an USB host controller, for outputting the data transmitted from the firmware.

15. The apparatus of claim 14, wherein the plural programs include: a virtue bus driver, an USB device driver, a remote USB host controller driver, a servo application, and a W/WL LAN driver.
